(19) United States
(12) Patent Application Publication
(10) Pub. No.: US 2014/0084216 A1
(43) Pub. Date: Mar. 27, 2014

(54) PARTICLES FOR ELECTROPHORETIC DISPLAYS

(71) Applicants: Louise Diane Farrand, Dorset (GB); Jonathan Henry Wilson, Southampton (GB); Mark John Goulding, Ringwood (GB); Sean Butterworth, St. Annes (GB); Stephen Georg Yeates, Macclesfield (GB); Brian Saunders, Manchester (GB)

(72) Inventors: Louise Diane Farrand, Dorset (GB); Jonathan Henry Wilson, Southampton (GB); Mark John Goulding, Ringwood (GB); Sean Butterworth, St. Annes (GB); Stephen Georg Yeates, Macclesfield (GB); Brian Saunders, Manchester (GB)

(73) Assignee: Merck Patent GmbH, Darmstadt (DE)

(21) Appl. No.: 14/116,501

(22) PCT Filed: Apr. 28, 2012
(86) PCT No.: PCT/EP2012/001845

§ 371 Date: Nov. 8, 2013

(30) Foreign Application Priority Data
May 9, 2011 (EP) 11003773.6

(51) Int. Cl. G02F 1/167

(52) U.S. Cl. CPC G02F 1/167
USPC 252/500; 524/853; 524/850

(57) ABSTRACT

This invention relates to electrophoretic fluids comprising, preferably coloured, polymer particles having non-spherical shape, and the use of these particles for the preparation of mono, bi or polychromal electrophoretic devices.

This invention relates to electrophoretic fluids comprising, preferably coloured, polymer particles having non-spherical shape, and the use of these particles for the preparation of mono, bi or polychromal electrophoretic devices.

Particles suitable for use in electrophoretic displays (EPD), e.g. coloured electronic paper have been exemplified in recent patent literature; e.g. (U.S. Pat. No. 7,304,634, GB 2 438 436, US 2007/0268244). It is now possible to control and manipulate features such as size, colour, charge and polydispersity independently to produce particles with desired properties for EPD; e.g. WO 2010/089057. Reported state of the art polymer microparticles for EPD are regularly spherical in nature because of their production process. Pigment based particles tend to be very polydisperse because they are derived from milling larger particles in an energy intensive process.

Although it is possible to control many features of polymeric particles so that they are suitable for EPD, there has been no method previously reported to additionally control the shape of such particles. In the case that particles are spherical, and the same size, packing is limited to around 64%. Realistically volume fractions of particles are likely to be lower than 60%, which can impact on the optical density of the display, the ‘hiding power’ of the particles and the contrast ratio achievable.

Other shapes, such as lamellae, rectangular shapes may pack more efficiently which could increase the optical density of the particles. Shapes such as ‘torpedo’ or rods could switch more quickly due to reduced drag forces in certain directions, making them more fluid dynamic.

However, it is difficult to synthesise non-spherical particles because surface tension favours spherical shapes. This may be partly overcome by using techniques such as microfluidics, but this produces small yields and is as yet unsuitable as a production process. Special preparations of non-spherical particles are described in Fujibayashi et al, Langmuir 2007, 23, 7958-7962; Kaneko et al, Macromolecules, 2004, 37 (2), 501; Kim et al, Adv. Mater., 2007, 19, 2005; Mock et al, Langmuir 2006, 22, 4037; Elsesser et al, Langmuir 2011, 27(3), 917-927. In summary, there is no prior art which describes the preparation of polymeric particles of sub-micron size, which are suitable for EPD and which aim to control shape. There is a need for a simple and flexible preparation of particles with well-defined shapes.

The present invention provides an electrophoretic fluid comprising polymer particles having non-spherical shapes. The non-spherical polymer particles are preferably prepared by a process comprising the following steps:

(a) polymerising a first non-aqueous dispersion of at least one monomer, preferably at least one steric stabiliser, at least one initiator, optionally at least one polymerisable dye and optionally at least one charged co-monomer in a non-aqueous solvent,
(b) optionally cleaning the polymer particles formed in step (a) and forming a second non-aqueous dispersion of the polymer particles in a non-aqueous solvent,
(c) adding to the second non-aqueous dispersion at least one monomer having a partition coefficient different from the partition coefficient of the non-aqueous solvent, preferably at least one steric stabiliser, and at least one initiator,
(d) polymerising the second non-aqueous dispersion, and
(e) optionally cleaning the polymer particles formed in step (d).

Preferably, step (c) comprises adding to the second non-aqueous dispersion at least one monomer having a partition coefficient different from the partition coefficient of the non-aqueous solvent and different from the partition coefficient of the monomers in step (a).

The subject matter of this invention relates also to the use of particles prepared by the described process for the preparation of optical, electrooptical, electronic, electrochemical, electrophotographic, electrowetting and mono, bi or polychromal electrophoretic displays and/or devices. The present invention specifically provides electrophoretic fluids comprising coloured polymer particles having non-spherical shapes, especially such particles made by the described process.

The present invention provides a simple two-step process of preparing non-spherical sub-micron sized polymeric particles suitable for EPD. The preparation method is entirely suitable for EPD. Polymer particles according to the invention can be of any non-spherical shape. Preferably, the polymer particles are elongated (tactoidal), raspberry like (bumps on the surface) or square-like.

This route provides a two-step reaction to provide coloured particles suitable for EPD, in a solvent suitable for use in EPD; i.e. a non-polar hydrocarbon solvent. This eliminates any requirement of freeze or spray drying or solvent transfer enabling a cost effective production process. All prior art describes an aqueous based system to swell particles. However, it is not possible, even using techniques such as spray or freeze drying to remove all traces of water from polymeric particles such that they easily redisperse in a non-polar solvent such as dodecane. Even if it was possible to prepare and transfer the particles from an aqueous to a hydrocarbon solvent, this would be undesirable due to possible contamination (introduction of undesired polar species) and production costs.

The particles are surface modified to promote dispersability and the holding of a charge. The particles can be coloured by a physical, chemical and irreversible entrapment of a polymerisable dye. Any shade or colour of dye is possible. A mixture of dyes can also be used to achieve a desired colour.

The particles can be easily dispersed in dielectric organic media, which enable electrophoretic switching of the particles in an applied electric field, preferably as the electrically switchable component of a full colour e-paper or electrophoretic display. Particle size can be controlled with a monodisperse size distribution for image quality. The particles can be cross-linked so they have a non-swelling nature when dispersed in EPD solvent media, additionally impact strength and hardness. The particles are easily dispersible in a non polar continuous phase that is the most used media for EPD. The particles have a high electrophoretic mobility in dielectric media.

Further advantages of the polymer particles according to the invention may be, alone or in combination, accurate zeta potential is possible, all colours have same density (good for sedimentation/agglomeration performance), excellent switching behaviour, faster response times at comparable voltages, consistent surface properties, good reproducibility, and/or densities close to that of the carrier fluid. These properties make them potential materials for a large range of applications such as new display modes, electrophoretic displays and as additives in liquid crystalline mixtures.

The polymer particles of the invention can be prepared in a simple 2-step reaction in a non-aqueous, preferably non-polar solvent, comprising the following steps:

(a) polymerising a first non-aqueous dispersion of at least one monomer, preferably at least one steric stabiliser, at least one initiator, optionally at least one polymerisable dye and optionally at least one charged co-monomer in a non-aqueous solvent thereby forming polymer particles (A),
(b) optionally cleaning the polymer particles (A) formed in step (a) and forming a second non-aqueous dispersion of the polymer particles (A) in a non-aqueous solvent,
(c) adding to the second non-aqueous dispersion at least one monomer having a partition coefficient different from the partition coefficient of the non-aqueous solvent, preferably at least one steric stabiliser, and at least one initiator,
(d) polymerising the second non-aqueous dispersion thereby forming polymer particles (B), and
(e) optionally cleaning the polymer particles (B) formed in step (d).

Preferably, step (c) comprises adding to the second non-aqueous dispersion at least one monomer having a partition coefficient different from the partition coefficient of the non-aqueous solvent and different from the partition coefficient of the monomers in step (a).

Preferably, the polymer particles (A) formed in step (a) are cleaned by centrifugation and washing, or a stirred cell filtration system can be used. The dispersion is washed with a non-aqueous solvent.

The preferred non-aqueous solvent used in all process steps are non-polar hydrocarbon solvents, especially such used in EPD fluids, i.e. the Isopar series (Exxon-Mobil), Norpar, Shell-Sol (Shell), Sol-Trol (Shell), naphtha, and other petroleum solvents, tetralin, 1,5-dimethyltetralin, decalin, as well as long chain alkanes such as dodecane, tetradecane, decane and nonane. Especially preferred is dodecane.

In step (c), the second dispersion is then treated with a monomer which has a partition coefficient different from the partition coefficient of the non-aqueous solvent.

Preferably, step (c) comprises adding to the second non-aqueous dispersion at least one monomer having a partition coefficient different from the partition coefficient of the non-aqueous solvent and different from the partition coefficient of the monomers in step (a).

The partition coefficient is specified as log P value. The log P scale is the octanol-water partition coefficient.

log Poct/wat=log 10([monomer]oct/[monomer]wat)

Log P is preferably measured using the shake flask method known to those skilled in the art. Further description of this method may be found in general textbooks and in the literature, such as in the review article by Leo et al, Chem. Rev. 71, (6), 525-616 (1971). Log P values are found in Scifinder and are calculated using Advanced Chemistry Development (ACD/Labs) Software V11.02 (1994-2011 ACD/Labs). The log P value herein refers to the logarithm of the ratio of the mass concentration of a monomer in octanol divided by the mass concentration of the monomer in water at equilibrium measured at 25° C. and pH 7.

This is a scale which describes the distribution of a substance between two phases, one of which is very hydrophilic, and the other hydrophobic or more apolar. The log P value is an indication of how much of the compound can be found in either phase, the higher the number the more hydrophobic it will be so will reside in the octanol. The lower the number, the more hydrophilic/polar the chemical. This scale infers which monomers will be insoluble in the non-aqueous solvent, but may swell the PMMA particles. The log P value of the monomer has to be dissimilar to the log P value of the non-aqueous solvent. The greater the difference in log P between the second stage monomer (swelling monomer) and the non-aqueous solvent the more pronounced the effect becomes.

This effect is even more pronounced, the greater the difference in log P between the second stage monomer and the non-aqueous solvent, and the second stage monomer and the first stage monomer.

Monomer/non-aqueous solvent combinations with a difference of log P values of 3 to 9, preferably 4 to 9, can be used. Preferably combinations with a difference of log P values of 4.0 to 8.5, preferably 5.0 to 8.5, are used.

Examples of suitable monomers are the following shown with predicted log P values: 2-Propenoic acid, 2-[2-(2-propen-1-yloxy)ethoxy]ethyl ester (1.028), Propenoic acid, 2-methyl-, 1,1′-[2-(phosphonooxy)-1,3-propanediyl]ester (−0.79), 2-Propenoic acid, 2-methyl-, 3,6,9,12-tetraoxamidec-1-yl ester (0.227), 2-Propenoic acid, 2-methyl-, 2-[[bis(dimethylamino)phosphinyl]-oxy]ethyl ester (0.922), 2-Hydroxyethyl acrylate (0.009), 2-Hydroxy-2-methylethyl acrylate (0.363), 2-Propenoic acid, 2-methyl-, 2-(2-hydroxyethoxy)ethyl ester (0.215), Propanoic acid, 2-oxo-, 2-oxiranylmethyl ester (−0.49), 2-Propenoic acid, 2-borono-, 1-methyl ester (−0.333), 2-Propenoic acid, 3-sulfopropyl ester (−1.285), 2-Propenoic acid, 3-hydroxy-2,2-bis(hydroxymethyl)propyl ester (−0.959), Tetraethylene glycol monoacrylate (−0.674), 2-Carboxyethyl acrylate (0.313), 1,3-Propanediol monoacrylate (0.218), 2-Propenoic acid, 2-methyl-, (dimethoxymethylsilyl)-methyl ester (−0.512), 2-Propenoic acid, 2-methyl-, (dimethoxyphosphinyl)methyl ester (0.084), Methacrylamide (−0.143), acrylamide (−0.167), vinyl acetate (0.629), 2-Hydroxyethyl Methacrylate (0.427), N-Hydroxyethyl acrylamide (−1.372), glycidyl methacrylate (0.342).

Preferred are 2-hydroxyethyl methacrylate (log P 0.427), N-hydroxyethyl acrylamide (−1.372), 2-Hydroxyethyl acrylate (0.009), 2-Propenoic acid, 3-sulfopropyl ester (−1.285), Methacrylamide (−0.143), and/or vinyl acetate (log P 0.629).

Preferred monomer/non-aqueous solvent combinations are 2-hydroxyethyl methacrylate (log P 0.427), N-hydroxyethyl acrylamide (log P −1.372) and/or vinyl acetate (log P 0.629) in combination with dodecane (log P 6.821).

The same stabilisers and initiators as described below for use in step (a) may be used in step (c).

After adding the monomer in step (c) the dispersion is preferably stirred for up to 24 hours, preferably for 1-24, especially 16-24, hours, before additional stabiliser is added.

In polymerisation step (d), the mixture is preferably heated to a temperature at which an added initiator initiates the polymerisation of the added monomer. The mixture is stirred at this temperature for at least 1 hour, preferably 2 hours and allowed to cool to room temperature. In step (e), the dispersion is preferably cleaned by centrifugation or stirred filtration and washing with clean non-aqueous solvent. When particles are observed by SEM, the shape is changed from spherical. The resultant shape can be controlled by the type of monomer added to the seed particle.

Preferably the final polymer particles are simply separated from the reaction suspension by filtration, preferably by pouring the suspension through a pore size filter, i.e. a 0.1 μm pore size filter, or the particles can be cleaned by centrifuging.

The selection of the polymerisation conditions of step (a) depends on the required size and size distribution of the particles. Adjustment of polymerisation conditions is well known to someone skilled in the art.

Preferably, a batch polymerisation process is used in the first polymerisation step wherein all reactants are completely added at the outset of the polymerisation process. In such process only relatively few variables have to be adjusted for a given formulation. Preferred changes which can be made in such cases are to the reaction temperature, reactor design and the type and speed of stirring. Thus, a batch polymerisation process is used for manufacture versus a semi-continuous batch process because of limited versatility and simple evaluations of reaction formulation. However, starve-fed addition is also possible.

Preferably the polymerisation according to the invention is a free radical polymerisation.

Usually, a monomer composition according to step (a) of the process according to the invention comprises at least one monomer, preferably at least one steric stabiliser, at least one initiator, optionally at least one polymerisable dye and optionally at least one charged co-monomer in a non-aqueous solvent

Preferably, a monomer composition of step (a) according to the invention comprises at least one polymerizable dye, at least one monomer, a steric stabiliser, an initiator, and a non-aqueous, non-polar solvent.

The monomers described in the following for preparation of the polymeric particles can be combined with the polymerisable dyes to produce a polymerisable dye/monomer mixture and/or the monomers can be incorporated stepwise into the polymerisable mixture to produce special effects, for example a core-shell effect so that there is more dye on the shell of the particles. Particularly preferable are monomers which are similar to the polymerisable dye, such as methyl methacrylate with disperse red 1 acrylate.

The particles can be prepared from most monomer types, in particular methacrylates, acrylates, acrylamides, methacrylamides, acrylonitriles, α-substituted acrylates, styrenes and vinyl ethers, vinyl esters, propenyl ethers, oxetanes and epoxys but would typically be prepared from largest percentage to be monomer, then cross-linker, and include a charged monomer (e.g. quaternised monomer).

The following are all examples which could be used and which are commercially available from the Sigma-Aldrich chemical company. Mixtures of monomers may also be used.

### Methacrylates:

Methyl methacrylate (MMA), Ethyl methacrylate (EMA), n-Butyl methacrylate (BMA), 2-Aminoethyl methacrylate hydrochloride, Allyl methacrylate, Benzyl methacrylate, 2-Butoxyethyl methacrylate, 2-(tert-Butylamino)ethyl methacrylate, Butyl methacrylate, tert-Butyl methacrylate, Caprolactone 2-(methacryloyloxy)ethyl ester, 3-Chloro-2-hydroxypropyl methacrylate, Cyclohexyl methacrylate, 2-(Diethylamino)ethyl methacrylate, Di(ethylene glycol) methyl ether methacrylate, 2-(Dimethylamino)ethyl methacrylate, 2-Ethoxyethyl methacrylate, Ethylene glycol dicyclopentenyl ether methacrylate, Ethylene glycol methyl ether methacrylate, Ethylene glycol phenyl ether methacrylate, 2-Ethylhexyl methacrylate, Furfuryl methacrylate, Glycidyl methacrylate, Glycosyloxyethyl methacrylate, Hexyl methacrylate, Hydroxybutyl methacrylate, 2-Hydroxyethyl methacrylate, 2-Hydroxyethyl methacrylate, Hydroxypropyl methacrylate Mixture of hydroxypropyl and hydroxyisopropyl methacrylates, 2-Hydroxypropyl 2-(methacryloyloxy)ethyl phthalate, Isobornyl methacrylate, Isobutyl methacrylate, 2-Isocyanatoethyl methacrylate, Isodecyl methacrylate, Lauryl methacrylate, Methacryloyl chloride, Methacrylic acid, 2-(Methylthio)ethyl methacrylate, mono-2-(Methacryloyloxy)ethyl maleate, mono-2-(Methacryloyloxy)ethyl succinate, Pentabromophenyl methacrylate, Phenyl methacrylate, Phosphoric acid 2-hydroxyethyl methacrylate ester, Stearyl methacrylate, 3-Sulfopropyl methacrylate potassium salt, Tetrahydrofurfuryl methacrylate, 3-(Trichlorosilyl)propyl methacrylate, Tridecyl methacrylate, 3-(Trimethoxysilyl)propyl methacrylate, 3,3,5-Trimethylcyclohexyl methacrylate, Trimethylsilyl methacrylate, Vinyl methacrylate. Preferably Methyl methacrylate (MMA), Methacrylic acid, Ethyl methacrylate (EMA), and/or n-Butyl methacrylate (BMA) are used.

### Acrylates:

Acrylic acid, 4-Acryloylmorpholine, [2-(Acryloyloxy)ethyl]trimethylammonium chloride, 2-(4-Benzoyl-3-hydroxyphenoxy)ethyl acrylate, Benzyl 2-propylacrylate, 2-Butoxyethyl acrylate, Butyl acrylate, tert-Butyl acrylate, 2-[(Butylamino)carbonyl]oxy]ethyl acrylate, tert-Butyl 2-bromoacrylate, 4-tert-Butylcyclohexyl acrylate, 2-Carboxyethyl acrylate, 2-Carboxyethyl acrylate oligomers anhydrous, 2-(Diethylamino)ethyl acrylate, i(ethylene glycol) ethyl ether acrylate technical grade, Di(ethylene glycol) 2-ethylhexyl ether acrylate, 2-(Dimethylamino)ethyl acrylate, 3-(Dimethylamino)propyl acrylate, Dipentaerythritol penta-/hexa-acrylate, 2-Ethoxyethyl acrylate, Ethyl acrylate, 2-Ethylacryloyl chloride, Ethyl 2-(bromomethyl)acrylate, Ethyl cis-(β-cyano)acrylate, Ethylene glycol dicyclopentenyl ether acrylate, Ethylene glycol methyl ether acrylate, Ethylene glycol phenyl ether acrylate, Ethyl 2-ethylacrylate, 2-Ethylhexyl acrylate, Ethyl 2-propylacrylate, Ethyl 2-(trimethylsilylmethyl)acrylate, Hexyl acrylate, 4-Hydroxybutyl acrylate, 2-Hydroxyethyl acrylate, 2-Hydroxy-3-phenoxypropyl acrylate, Hydroxypropyl acrylate, Isobornyl acrylate, Isobutyl acrylate, Isodecyl acrylate, Isooctyl acrylate, Lauryl acrylate, Methyl 2-acetamidoacrylate, Methyl acrylate, Methyl α-bromoacrylate, Methyl 2-(bromomethyl)acrylate, Methyl 3-hydroxy-2-methylenebutyrate, Octadecyl acrylate, Pentabromobenzyl acrylate, Pentabromophenyl acrylate, Poly(ethylene glycol) methyl ether acrylate, Poly(propylene glycol) acrylate, Poly(propylene glycol) methyl ether acrylate Soybean oil, epoxidized acrylate, 3-Sulfopropyl acrylate potassium salt, Tetrahydrofurfuryl acrylate, 3-(Trimethoxysilyl)propyl acrylate, 3,5,5-Trimethylhexyl acrylate. Preferably Methyl acrylate, acrylic acid, Ethyl acrylate (EMA), and/or n-Butyl acrylate (BMA) are used.

### Acrylamides:

2-Acrylamidoglycolic acid, 2-Acrylamido-2-methyl-1-propanesulfonic acid, 2-Acrylamido-2-methyl-1-propanesulfonic acid sodium salt solution, (3-Acrylamidopropyl)trimethylammonium chloride solution, 3-Acryloylamino-1-propanol solution purum, N-(Butoxymethyl)acrylamide, N-tert-Butylacrylamide, Diacetone acrylamide, N,N-Dimethylacrylamide, N-[3-(Dimethylamino)propyl]methacrylamide, N-Hydroxyethyl acrylamide, N-(Hydroxymethyl)acrylamide, N-(Isobutoxymethyl)acrylamide, N-Isopropylacrylamide, N-Isopropylmethacrylamide, Methacrylamide, N-Phenylacrylamide, N-[Tris(hydroxymethyl)methyl]acrylamide,

### Styrenes

Styrene, Divinyl benzene, 4-Acetoxystyrene, 4-Benzyloxy-3-methoxystyrene, 2-Bromostyrene, 3-Bromostyrene, 4-Bromostyrene, α-Bromostyrene, 4-tert-Butoxystyrene, 4-tert-Butylstyrene, 4-Chloro-α-methylstyrene, 2-Chlorostyrene, 3-Chlorostyrene, 4-Chlorostyrene, 2,6-Dichlorostyrene, 2,6-Difluorostyrene, 1,3-Diisopropenylbenzene, 3,4-Dimethoxystyrene, α,2-Dimethylstyrene, 2,4-Dimethylstyrene, 2,5-Dimethylstyrene, N,N-Dimethylvinylbenzylamine, 2,4-Diphenyl-4-methyl-1-pentene, 4-Ethoxystyrene, 2-Fluorostyrene, 3-Fluorostyrene, 4-Fluorostyrene, 2-Isopropenylaniline, 3-Isopropenyl-α,α-dimethylbenzyl isocyanate, Methylstyrene, α-Methylstyrene, 3-Methylstyrene, 4-Methylstyrene, 3-Nitrostyrene, 2,3,4,5,6-Pentafluorostyrene, 2-(Trifluoromethyl)styrene, 3-(Trifluoromethyl)styrene, 4-(Trifluoromethyl)styrene, 2,4,6-Trimethylstyrene. Preferably Styrene and/or Divinyl benzene are used.

### Vinyl Groups

3-Vinylaniline, 4-Vinylaniline, 4-Vinylanisole, 9-Vinylanthracene, 3-Vinylbenzoic acid, 4-Vinylbenzoic acid, Vinylbenzyl chloride, 4-Vinylbenzyl chloride, (Vinylbenzyl)trimethylammonium chloride, 4-Vinylbiphenyl, 2-Vinylnaphthalene, 2-Vinylnaphthalene, Vinyl acetate, Vinyl benzoate, Vinyl 4-tert-butylbenzoate, Vinyl chloroformate, Vinyl chloroformate, Vinyl cinnamate, Vinyl decanoate, Vinyl neodecanoate, Vinyl neononanoate, Vinyl pivalate, Vinyl propionate, Vinyl stearate, Vinyl trifluoroacetate,

Other monomers which may be used are those which have groups to help stabilisation of the particles, e.g. Poly(ethylene glycol) methyl ether acrylate, Poly(ethylene glycol) phenyl ether acrylate, lauryl methacrylate, Poly(ethylene glycol) methyl ether acrylate, Poly(propylene glycol) methyl ether acrylate, Lauryl acrylate and fluorinated monomers of above.

Some of the monomers have groups for further reaction if so desired, e.g. Glycidyl ethacrylate, 2-Hydroxyethyl methacrylate.

The following compounds can be used as intraparticle crosslinking monomers for solubility control and solvent swelling resistance: ethylene glycol dimethacrylate (EGDMA), allyl methacrylate (ALMA), divinyl benzene, Bis[4-(vinyloxy)butyl]adipate, Bis[4-(vinyloxy)butyl]1,6-hexanediylbiscarbamate, Bis[4-(vinyloxy)butyl]isophthalate, Bis[4-(vinyloxy)butyl](methylenedi-4,1-phenylene)biscarbamate, Bis[4-(vinyloxy)butyl]succinate, Bis[4-(vinyloxy)butyl]terephthalate, Bis[4-(vinyloxymethyl)cyclohexylmethyl]glutarate, 1,4-Butanediol divinyl ether, 1,4-Butanediol vinyl ether, Butyl vinyl ether, tert-Butyl vinyl ether, 2-Chloroethyl vinyl ether, 1,4-Cyclohexanedimethanol divinyl ether, 1,4-Cyclohexanedimethanol vinyl ether, Di(ethylene glycol)divinyl ether, Di(ethylene glycol) vinyl ether, Ethylene glycol butyl vinyl ether, Ethylene glycol vinyl ether, Tris[4-(vinyloxy)butyl]trimellitate, 3-(Acryloyloxy)-2-hydroxypropyl methacrylate, Bis[2-(methacryloyloxy)ethyl]phosphate, Bisphenol A propoxylate diacrylate, 1,3-Butanediol diacrylate, 1,4-Butanediol diacrylate, 1,3-Butanediol dimethacrylate, 1,4-Butanediol dimethacrylate, N,N′-(1,2-Dihydroxyethylene)bisacrylamide, Diethylene glycol diacrylate, Di(trimethylolpropane)tetraacrylate, Diurethane dimethacrylate, N,N′-Ethylenebis(acrylamide), Ethylene glycol diacrylate, Glycerol 1,3-diglycerolate, Glycerol dimethacrylate, 1,6-Hexanediol diacrylate, 1,6-Hexanediol dimethacrylate, 1,6-Hexanediylbis[oxy(2-hydroxy-3,1-propanediyl)]bisacrylate, Hydroxypivalyl hydroxypivalate bis[6-(acryloyloxy)hexanoate], Neopentyl glycol diacrylate, Pentaerythritol diacrylate, Pentaerythritol tetraacrylate, Pentaerythritol triacrylate, Poly(propylene glycol)diacrylate, Poly(propylene glycol)dimethacrylate, Tetra(ethylene glycol)diacrylate, 1,3,5-Triacryloylhexahydro-1,3,5-triazine, Tricyclo[5.2.1.0]decanedimethanol diacrylate, Trimethylolpropane benzoate diacrylate, Trimethylolpropane ethoxylate methyl ether diacrylate, Trimethylolpropane ethoxylate triacrylate, Trimethylolpropane triacrylate, Trimethylolpropane trimethacrylate, Tris[2-(acryloyloxy)ethyl]isocyanurate, Tri(propylene glycol)diacrylate.

Optionally, the monomer composition comprises at least one charged co-monomer.

Examples of cationic monomers for particle stability and particle size control are 2-methacryloxy ethyl trimethyl ammonium chloride (MOTAC), acryloxy ethyl trimethyl ammonium chloride (AOTAC), [3-(Methacryloylamino)propyl]trimethylammonium chloride, [2-(Methacryloyloxy)ethyl]trimethylammonium methyl sulfate solution, tetraallyl ammonium chloride, diallyl dimethyl ammonium chloride, (Vinylbenzyl)trimethylammonium chloride. Preferably 2-methacryloxy ethyl trimethyl ammonium chloride (MOTAC) and acryloxy ethyl trimethyl ammonium chloride (AOTAC) are used.

Examples of anionic monomers are sodium, potassium or triethylamine salts of methacrylic acid, Acrylic acid, 2-(Trifluoromethyl)acrylic acid, 3-(2-Furyl)acrylic acid, 3-(2-Thienyl)acrylic acid, 3-(Phenylthio)acrylic acid, Poly(acrylic acid) potassium salt, Poly(acrylic acid) sodium salt, Poly(acrylic acid), Poly(acrylic acid, sodium salt) solution, trans-3-(4-Methoxybenzoyl)acrylic acid, 2-Methoxycinnamic acid, 3-Indoleacrylic acid, 3-Methoxycinnamic acid, 4-Imidazoleacrylic acid, 4-Methoxycinnamic acid, Poly(styrene)-block-poly(acrylic acid), Polyacrylonitrile-co-butadiene-co-acrylic acid), dicarboxy terminated, Poly(acrylonitrile-co-butadiene-co-acrylic acid), dicarboxy terminated, glycidyl methacrylate diester, 2,3-Diphenyl-Acrylic Acid, 2-Me-Acrylic Acid, 3-(1-Naphthyl)Acrylic Acid, 3-(2,3,5,6-Tetramethylbenzoyl)Acrylic Acid, 3-(4-Methoxyphenyl)Acrylic Acid, 3-(4-Pyridyl)Acrylic Acid, 3-p-Tolyl-Acrylic Acid, 5-Norbornene-2-Acrylic Acid, Trans-3-(2,5-Dimethylbenzoyl)Acrylic Acid, Trans-3-(4-Ethoxybenzoyl)Acrylic Acid, Trans-3-(4-Methoxybenzoyl)Acrylic Acid, 2,2′-(1,3-Phenylene)Bis(3-(2-aminophenyl)Acrylic Acid), 2,2′-(1,3-Phenylene)Bis(3-(2-Aminophenyl)Acrylic Acid) hydrochloride, 2,2′-(1,3-Phenylene)Bis(3-(2-Nitrophenyl)Acrylic Acid), 2-[2-(2′,4′-Difluoro[1,1′-Biphenyl]-4-Yl)-2-Oxoethyl]Acrylic Acid, 2-(2-(2-Chloroanilino)-2-Oxoethyl)-3-(4-Methoxyphenyl)Acrylic Acid, 2-(2-((2-Hydroxyethyl)Amino)-2-Oxoethyl)-3-(4-Methoxyphenyl)Acrylic Acid, 2-(2-(Cyclohexylamino)-2-Oxoethyl)-3-(4-Methoxyphenyl)Acrylic Acid.

A preferred monomer seed composition comprises methyl methacrylate and methacrylic acid and optionally ethylene glycol dimethacrylate.

In a preferred variant of the invention, the polymer particles are prepared by copolymerisation of at least one polymerisable dye in step (a).

The function of the polymerisable dye is to colour the particle. The polymerisable dye consists of a chromophore, one or more polymerisable groups, optional linker groups (spacers), and optional groups to modify physical properties (like solubility, light fastness, etc.) and optionally charged group(s).

The polymerisable dye preferably comprises a chromophoric group and a functional group or plurality of functional groups selected from polymerisable groups, e.g. methacrylates, acrylates, methacrylamides, acrylonitriles, α-substituted acrylates, styrenes and vinyl ethers, vinyl esters, propenyl ethers, oxetanes and epoxys etc., in particular methacrylates and acrylates.

The polymerisable group may be attached directly to the chromophoric group or may be attached through a linker group. An example of a suitable linker group is an optionally substituted alkyl chain, a polyether alkyl chain, a cycloalkyl or aromatic ring, heteroaromatic ring or a combination thereof.

The chromophoric group preferably comprises of conjugated aromatic (including heteroaromatic) and/or multiple bonds including: azo (including monoazo, bisazo, trisazo, linked azos etc), metallised azo, anthraquinone, pyrroline, phthalocyanine, polymethine, aryl-carbonium, triphenodioxazine, diarylmethane, triarylmethane, anthraquinone, phthalocyanine, methine, polymethine, indoaniline, indophenol, stilbene, squarilium, aminoketone, xanthene, fluorone, acridene, quinolene, thiazole, azine, induline, nigrosine, oxazine, thiazine, indigoid, quinonioid, quinacridone, lactone, benzodifuranone, flavonol, chalone, polyene, chroman, nitro, naphtholactam, formazene or indolene group or a combination of two or more such groups. Preferred chromophoric groups are azo groups (especially monoazo, and bisazo), anthraquinone and phthalocyanine groups.

Preferably the polymerisable dye comprises a chromophoric group and one or more functional groups selected from an acrylate or methacrylate backbone. In a preferred variant of the invention, the polymerisable dye comprises at least two polymerisable groups selected from an acrylate or methacrylate backbone.

A polymerisable dye may contain a single chromophore, for example with bright yellow, magenta or cyan colours and self shade blacks. However, it may also contain mixed covalently attached chromophores for example to obtain a black colour, by covalently attached brown and blue or yellow, magenta and cyan. Green can be obtained by yellow and cyan etc. Extended conjugated chromophores can also be used to obtain some shades. For example, bis- and trisazo compounds can be used to obtain blacks and other duller shades (navy blue, brown, olive green, etc).

Mixtures of polymerisable dyes can also be used to obtain the correct particle shade; for example a black from single component mixtures of brown and blue or yellow, magenta and cyan pre-polymerised dyes. Similarly shades can be tuned for example by adding small quantities of separate polymerisable dyes to modify the colour of the particles (e.g. 95% yellow and 5% cyan to get a greener yellow shade).

Especially, the polymerisable dyes described in WO 2010/089057 and WO 2010/089060 are suitable for incorporation in the polymer particles of the invention. Preferably acrylate or methacrylate derivatives of Disperse red 1, dyes of Formula 1, especially methacrylate or acrylate derivative of cationic Basic Blue 41, and dyes of Formula 2, especially with R5 and R6=CH₃ and Hal=Cl, and dyes of Formula 3, especially with R7 and R8=CH₃ are used as polymerisable dyes for the invention.

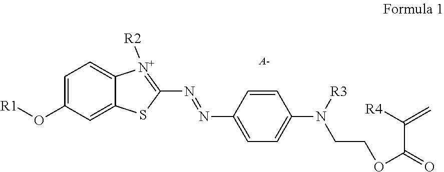

wherein R1,R2,R3=alkyl, preferably C1-C4 alkyl, R4=H or CH₃ A⁻=halogen, monobasic acid (oxo) anions, preferably acetate, propionate, lactate, methane sulphonate, p-toluenesulphonate, hydroxide, or nitrate, preferably with R1,R2,R4=CH₃ and R3=C₂H₅ and A⁻=methane sulfonate;

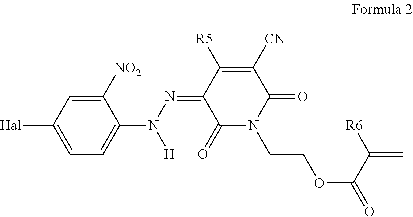

wherein R5=C1-C4 alkyl, preferably CH₃,
R6=H or CH3, preferably CH₃,
Hal=halogen, preferably Cl;

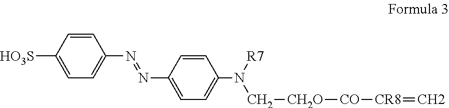

wherein R7=alkyl, preferably C1-C4 alkyl, especially CH₃,
R8=H or CH3, preferably CH₃.

Especially preferred are Disperse red 1 methacrylate, methacrylate derivative of cationic Basic Blue 41, and dye of Formula 3 with R7 and R8=CH₃. these dyes and their preparation are described in described in WO 2010/089057 and WO 2010/089060.

Preferred polymerisable dyes with at least two polymerisable groups may be chosen for example from compounds of Formula 4:

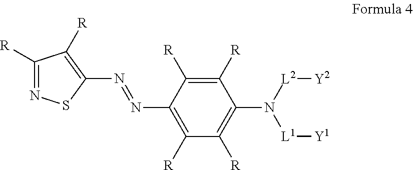

wherein
wherein the aromatic or heteroaromatic cycles are substituted by one or more different or identical groups R selected from the group consisting of H, alkyl, preferably C1-C6 alkyl, substituted or non-substituted aryl, —F, —Cl, —Br, —I, —OR′, —SR′, —C(O)R′, —C(O)OR′, —NHCOR′, —NO₂, —CN, —SO₃H, —NR′R″, preferably —CH₃, —NO₂, —CN, —COCH₃, —CO₂CH₂CH₃, —NHCOCH₃, with R′ and R″ independently of one another equal to H or alkyl, preferably C1-C6 alkyl,
and L¹ and L² are independently of one another a single bond, optionally substituted cycloalkyl or aromatic ring, linear or branched, optionally substituted, alkylene, where one or more non-adjacent C atoms may be replaced by O, S and/or N, and/or one or more double and/or triple bonds may be present in the chain and/or side chain or a combination thereof, preferably phenylene or C1-C6 alkyl, preferably identical, and
Y¹ and Y² are independently of one another, polymerisable group, preferably acrylate or methacrylate, preferably identical Preferably groups R are selected from H, C1-C6 alkyl, preferably CH₃, —C(O)R′, —C(O)OR′, —NO₂, —CN, —NHCOR′, with R′ independently of one another equal to C1-C6 alkyl, preferably C1 or C2 alkyl.

Preferably groups L¹ and L² are selected from phenylene or C1-C6 alkyl, a polyether alkyl chain, or a combination thereof, preferably C2-C4 alkyl, especially C2 and C4 alkyl. Especially identical groups L¹ and L² are preferred.

Preferably groups Y¹ and Y² are selected from acrylate and methacrylate. Especially identical groups Y¹ and Y² are preferred.

2-methacrylic acid 2-{[3-acetylamino-4-(4-cyano-3-methylisothiazol-5-ylazo)-phenyl]-[2-(2-methacryloyloxy)-ethyl]-amino}-ethyl ester is particularly preferred. The 2 step preparation procedure of this dye is shown in the following scheme 1. Similar dyes may be prepared accordingly.

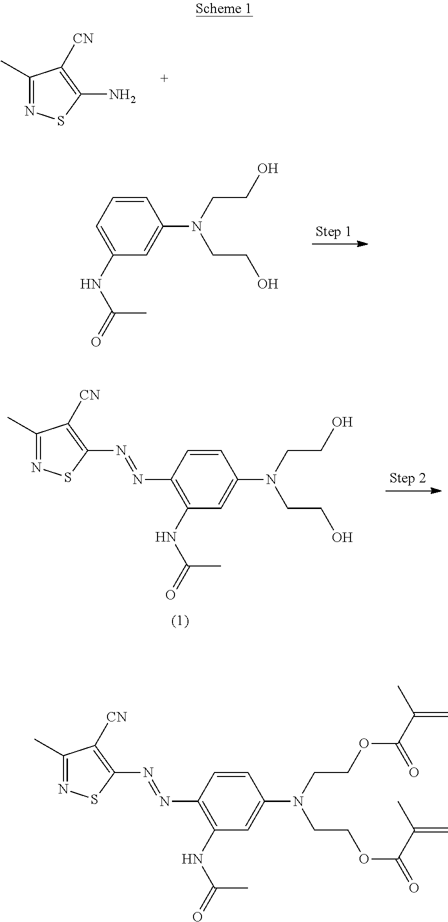

Preferably, an oil soluble initiator is used in order to control size, particle morphology and to reduce the residual monomers at the end of the reaction. Preferably an oil-soluble thermal initiator is added in step c) of the present process. Examples are 2,2′-Azobis(4-methoxy-2.4-dimethyl valeronitrile), 2,2′-Azobis(N-butyl-2-methylpropionamide), 2,2′-Azobis(2.4-dimethyl valeronitrile), Dimethyl 2,2′-azobis(2-methylpropionate), 2,2′-Azobis(2-methylbutyronitrile), also known as Vazo 67 (DuPont), 1,1′-Azobis(cyclohexane-1-carbonitrile), 2,2′-Azobis[N-(2-propenyl)-2-methylpropionamide], 1-[(1-cyano-1-methylethyl)azo]formamide, 2,2′-Azobis(N-cyclohexyl-2-methylpropionamide) (all available from Wako); Vazo 52 and Vazo 64 (available from DuPont), Luperox 331.

Preferably 2,2′-Azobis(2.4-dimethyl valeronitrile), Dimethyl 2,2′-azobis(2-methylpropionate), 2,2′-Azobis(2-methylbutyronitrile) or Vazo 67 are used.

To enhance the surface stabilisation or steric repulsions of the polymeric particles in a non-polar continuous phase, a steric stabiliser is preferably incorporated into the polymer particles. Preferably a non-aqueous dispersion (NAD) stabiliser is adsorbed in to the particle.

Suitable NAD stabilisers are block copolymers with a comb shape structure. Especially block copolymers with a molecular weight of approximately 10,000-100,000 can be used. The molecular weight ratio of the backbone to hairs may be approximately 1:1. The particle dispersion medium (non-polar solvent) preferably is a poor solvent for the backbone. The backbone chemistry preferably is similar to the particle. The hairs preferably are rigid and the length of the hairs preferably is of the order of the distance required to sterically stabilise the particles. The particle dispersion medium preferably is a good solvent for the hairs. It is possible to attach chromophores and/or charging groups to the backbone and or the hairs. NAD stabilisers are commercially available or can be prepared to known methods, e.g. as described in ‘Dispersion Polymerization in Organic Media’, ISBN 0471 054186, edited by K. E. J. Barrett, published by John Wiley and Sons, Copyright 1975, by Imperial Chemical Industries Ltd. Preferred NAD stabilisers are for example poly(hydroxystearic acid), and poly(hydroxystearic acid) graft (poly) methyl methacrylate and methacrylic acid copolymers, Solsperse 3000, Solsperse 11,200, Solsperse 13,300 and Solsperse 13,240 from Lubrizol Ltd., UK. Advantageously stabilisers comprising additionally copolymerised glycidyl methacrylate may be permanently locked in the polymer particle. This is simply done in the same vessel, by raising the temperature and adding diethanolamine. This opens up a glycidyl ring which is then available to polymerise with unreacted carboxylic acid groups from a methacrylic acid monomer.

Step (a) cross-linked copolymer particles can, preferably be prepared by copolymerisation of methyl methacrylate (MMA), methacrylic acid, dye monomer, 1-octanethiol and NAD stabiliser using azobisisobutyronitrile (AIBN) or 2,2′-Azobis(2-methylbutyronitrile (Vazo 67) as an initiator. Preferably, polymerisations are conducted using a batch process.

The polymerisable composition of step (a) usually comprises 0.1-15, preferably 1-10%, by weight of polymerisable dye, 50-95%, preferably 70-90%, by weight of monomer, 1-40%, preferably 1-10%, by weight of crosslinking monomer, 1-30%, preferably 1-10%, by weight of polar monomer and 0.1-10%, preferably 0.1-5%, by weight of initiator, all percentages are based on the total weight of the polymerizable composition (except solvent).

Step (d) copolymer particles can preferably be prepared by copolymerisation of monomers having a difference of log P from stage 1 monomers of between 0.5-3.0. Polymerisation conditions can range from starve-fed to batch addition.

The polymerisable composition of step (d) usually comprises 20-50%, preferably 25-35%, by weight of cross-linked particles which are optionally dyed, 15-40%, preferably 20-30%, by weight of stabiliser, 20-50%, preferably 30-45% of second stage monomer and 0.1-10%, preferably 0.1-5%, by weight of initiator, all percentages are based on the total weight of the polymerizable composition (except solvent).

Especially preferred are non-spherical coloured polymer particles prepared by polymerisation according to the described process of methyl methacrylate, methacrylic acid, a NAD stabiliser, at least one polymerisable dye, especially at least one of the preferred polymerisable dyes described above, and 2-hydroxyethyl methacrylate, N-hydroxyethyl acrylamide, 2-Hydroxyethyl acrylate, 2-Propenoic acid, 3-sulfopropyl ester, Methacrylamide, and/or vinyl acetate, especially 2-hydroxyethyl methacrylate, and/or vinyl acetate. Preferably, such polymer particles are prepared in dodecane.

Polymer particles prepared according to the invention are preferably particles with a size in the range of 50-1000 nm and preferably with a monodisperse size distribution. Preferred particle sizes are 100-900 nm, preferably 200-800 nm. Especially preferred are particles having a particle size of 300-800 nm. Particle sizes are determined by photon correlation spectroscopy of aqueous particle dispersions by a common apparatus such as a Malvern NanoZS particle analyser.

The size of polymer particles in electrophoretic fluids may be different because of the influence of solvents and/or surfactants.

Besides incorporation of a polymerisable dye into the polymer particles of the invention, dying of polymer particles can also be achieved by colouring polymer particles with a dye or with a polymerisable dyes and subsequent polymerisation of the dye within the particles as described in WO 2009/100803 and WO 2010/089059.

The dyes can also be pre-polymerised before being used for colouring polymer particles as described in WO 2010/089058.

Particles of the invention may be used in optical, electrooptical, electronic, electrochemical, electrophotographic, electrowetting and electrophoretic displays and/or devices.

Particles of the invention are primarily designed for use in electrophoretic displays (EPD). An EPD generally comprises charged electrophoretic particles dispersed between two substrates, each comprising one or more electrodes. The space between the electrodes is filled with a dispersion medium which is a different colour to the colour of the particles. If a voltage is applied between the electrodes, charged particles move to the electrode of opposite polarity. The particles can cover the observer's side electrode, so that a colour identical to the colour of the particles is displayed when an image is observed from the observer's side. Any image can be observed using a multiplicity of pixels. Available technologies of EPDs include electronic paper, commercially used in electronic books.

A typical electrophoretic display preferably consists of the particles dispersed in a low polar or non-polar solvent along with additives to improve electrophoretic properties, such as stability and charge. Examples of such dispersions are well described in the literature, for example U.S. Pat. No. 7,247,379; WO 99/10767; US 2007/0128352; U.S. Pat. No. 7,236,290; U.S. Pat. No. 7,170,670; U.S. Pat. No. 7,038,655; U.S. Pat. No. 7,277,218; U.S. Pat. No. 7,226,550; U.S. Pat. No. 7,110,162; U.S. Pat. No. 6,956,690; U.S. Pat. No. 7,052,766; U.S. Pat. No. 6,194,488; U.S. Pat. No. 5,783,614; U.S. Pat. No. 5,403,518; U.S. Pat. No. 5,380,362.

Typical additives to improve the stability of the fluid (either by steric stabilisation or by use as a charging agent) are known to experts in the field and include (but are not limited to) the Brij, Span and Tween series of surfactants (Aldrich), the Solsperse, Ircosperse and Colorburst series (Lubrizol), the OLOA charging agents (Chevron Chemicals) and Aerosol-OT (Aldrich).

Any other additives to improve the electrophoretic properties can be incorporated provided they are soluble in the formulation medium, in particular thickening agents or polymer additives designed to minimise settling effects.

The dispersion solvent can be chosen primarily on the basis of dielectric constant, refractive index, density and viscosity. A preferred solvent choice would display a low dielectric constant (<10, more preferably <5), high volume resistivity (about 10¹⁵ ohm-cm), a low viscosity (less than 5 cst), low water solubility, a high boiling point (>80° C.) and a refractive index and density similar to that of the particles. Tweaking these variables can be useful in order to change the behavior of the final application. For example, in a slow-switching application such as poster displays or shelf labels, it can be advantageous to have an increased viscosity to improve the lifetime of the image, at the cost of slower switching speeds. However in an application requiring fast switching, for example e-books and displays, a lower viscosity will enable faster switching, at the cost of the lifetime in which the image remains stable (and hence an increase in power consumption as the display will need more frequent addressing). The preferred solvents are often non-polar hydrocarbon solvents such as the Isopar series (Exxon-Mobil), Norpar, Shell-Sol (Shell), Sol-Trol (Shell), tetralin, 1,5-dimethyltetralin, decalin, naphtha, and other petroleum solvents, as well as long chain alkanes such as dodecane, tetradecane, decane and nonane). These tend to be low dielectric, low viscosity, and low density solvents. A density matched particle/solvent mixture will yield much improved settling/sedimentation characteristics and thus is desirable. For this reason, often it can be useful to add a halogenated solvent to enable density matching. Typical examples of such solvents are the Halocarbon oil series (Halocarbon products), or tetrachloroethylene, carbon tetrachloride, 1,2,4-trichlorobenzene and similar solvents. The negative aspect of many of these solvents is toxicity and environmental friendliness, and so in some cases it can also be beneficial to add additives to enhance stability to sedimentation rather than using such solvents.

The preferred additives and solvents used in the formulation of the particles of the invention are OLOA11000 (Chevron Chemicals), Ircosperse 2153 (Lubrizol Ltd), and dodecane (Sigma Aldrich)

Usually electrophoretic fluids comprise a charged inorganic nanoparticle such as titania, alumina or barium sulphate, coated with a surface layer to promote good dispersibility in dielectric media and a dielectric fluid media. The solvents and additives used to disperse the particles are not limited to those used within the examples of this invention and many other solvents and/or dispersants can be used. Lists of suitable solvents and dispersants for electrophoretic displays can be found in existing literature, in particular WO 99/10767) and WO 2005/017046) The Electrophoretic fluid is then incorporated into an Electrophoretic display element by a variety of pixel architectures, such as can be found in C. M. Lampert, Displays; 2004, 25(5) published by Elsevier B.V., Amsterdam.

The Electrophoretic fluid may be applied by several techniques such as inkjet printing, slot die spraying, nozzle spraying, and flexographic printing, or any other contact or contactless printing or deposition technique. Electrophoretic displays comprise typically, the electrophoretic display media in close combination with a monolithic or patterned backplane electrode structure, suitable for switching the pixels or patterned elements between the black and white optical states or their intermediate greyscale states.

The electrophoretic particles according to the present invention are suitable for all known electrophoretic media and electrophoretic displays, e.g. flexible displays, one particle systems, two particle systems, dyed fluids, systems comprising microcapsules, microcup systems, air gap systems and others as described in C. M. Lampert, Displays; 2004, 25(5) published by Elsevier B.V., Amsterdam. Examples of flexible displays are dynamic keypads, e-paper watches, dynamic pricing and advertising, e-readers, rollable displays, smart card media, product packaging, mobile phones, lab tops, display card, digital signage.

The disclosures in the cited references are thus expressly also part of the disclosure content of the present application. The following examples explain the present invention in greater detail without restricting the scope of protection.

### EXAMPLES

The characterisation of the formulations was performed using a Malvern NanoZS particle analyser. This instrument measures the size of particles in dispersion and the zeta potential of an electrophoretic fluid. The Zeta potential (ZP) is derived from the real-time measurement of the electrophoretic mobility and thus is an indicator of the suitability of the fluid for use in electrophoretic applications.

All chemicals are supplied by Sigma-Aldrich unless otherwise stated. Vazo 67 is supplied by Dupont, V59 is from Wako. Non-aqueous dispersion stabiliser (NADS) is prepared as described previously in WO 2010/089057 and is used as a solution in 50:50 ethyl acetate: butyl acetate. Sizing and aspect ratios of particles were performed using Image J software on SEM images. ImageJ is a public domain, Java-based image processing program. Length is measured as the longest distance from one side to another on a particle, width is a cross-section of this line.

### Example 1

### Preparation of PMMA Particles with 1 Wt % Ethylene Glycol Dimethacrylate (EGDMA) Cross-Linker

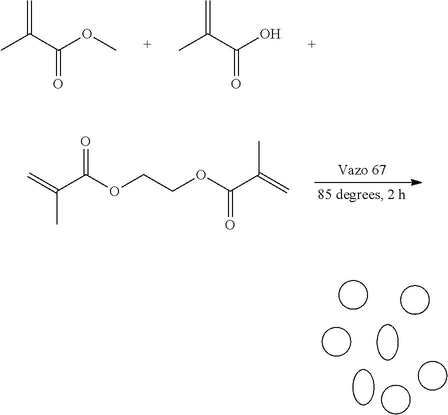

Vazo-67 initiator (0.17 g), NAD stabiliser (1.30 g, 30 weight % solution), methyl methacrylate (8.50 g), methacrylic acid (0.17 g), dodecanethiol (0.035 g), hexane (8.22 g) and dodecane (4.11 g) are added to a 100 ml 3-neck flask under a nitrogen atmosphere and stirred at 80° C. A solution of ethylene glycol dimethacrylate (0.87 g), hexane (0.8 g) and dodecane (0.4 g) are added to the reaction mixture at a rate of 0.1 ml/minute. After two hours, the flask is allowed to cool to room temperature. The dispersion is cleaned by centrifugation and replacing the supernatant with fresh solvent and redispersal of the particles three times. The particles are redispersed into dodecane to give an approximately 10 weight % particle dispersion (1). Particles appear spherical by SEM; size (424 nm), aspect ratio (1.015).

### Example 2

### Preparation of Anisotropic Particles with 2-Hydroxyethyl Methacrylate

Particle dispersion (1) (0.5 g, 10 wt %), NADS (0.1 g, 30 weight % solution), dodecane (0.5 g) and hydroxyethyl methacrylate (0.1 g) are stirred for 24 hours in a 10 ml single neck flask. Vazo 67 (5.0 mg), NADS (0.1 g, 30 weight %) and hexane (0.5 g) are added to the flask, the mixture is stirred at 80° C. for 2 hours. The resultant dispersion is filtered through glass wool. The dispersion is washed by centrifugation and the supernatant is replaced with clean dodecane. This process is repeated, the particles are redispersed in dodecane to give particle dispersion (2). Particles appear elongated by SEM; size (length 737 nm), aspect ratio (1.368).

### Example 3

### Preparation of Anisotropic Particles with 2-Hydroxyethyl Acrylamide

Particle dispersion (1) (20.0 g, 10 weight %), NADS (3.0 g, 30 weight % solution), dodecane (20.0 g) and hydroxyethyl acrylamide (3.0 g) are stirred for 24 hours in a 10 ml single neck flask under nitrogen. Vazo 67 (60 mg), NADS (2.0 g, 30 weight %) and hexane (20.0 g) are added to the flask, the mixture is stirred at 80° C. for 2 hours. The resultant dispersion is filtered through glass wool. The dispersion is washed by centrifugation and the supernatant is replaced with clean dodecane. This process is repeated, the particles are redispersed in dodecane to give particle dispersion (3). Particles appeared spherical with a random but well distributed series of bumps on the surface (raspberry like), SEM; size (350 nm), ratio large particles to bumps (7.5 times larger).

### Example 4

### Preparation of Square-Like Particles with Vinyl Acetate

Particle dispersion (1) (0.5 g, 10 weight %), NADS (0.1 g, 30 weight % solution), dodecane (0.5 g) and vinyl acetate (0.1 g) are stirred for 24 hours in a 10 ml single neck flask under nitrogen. Vazo 67 (5 mg), NADS (0.1 g, weight %) and hexane (0.5 g) are added to the flask, the mixture is stirred at 80° C. for 2 hours. The resultant dispersion is filtered through glass wool. The dispersion is washed by centrifugation and the supernatant is replaced with clean dodecane. This process is repeated, the particles are redispersed in dodecane to give particle dispersion (4). Particles appeared mainly square-like; SEM; size (562 nm), aspect ratio (1.003).

### Example 5

### Preparation of Magenta Dye-Acrylic Acid 2-[{3-acetylamino-4-(4-cyano-3-methylisothiazol-5-ylazo)-phenyl}-(2-acryloyloxyethyl}-amino]-ethyl ester

Prepared by a 3 step procedure as detailed below:

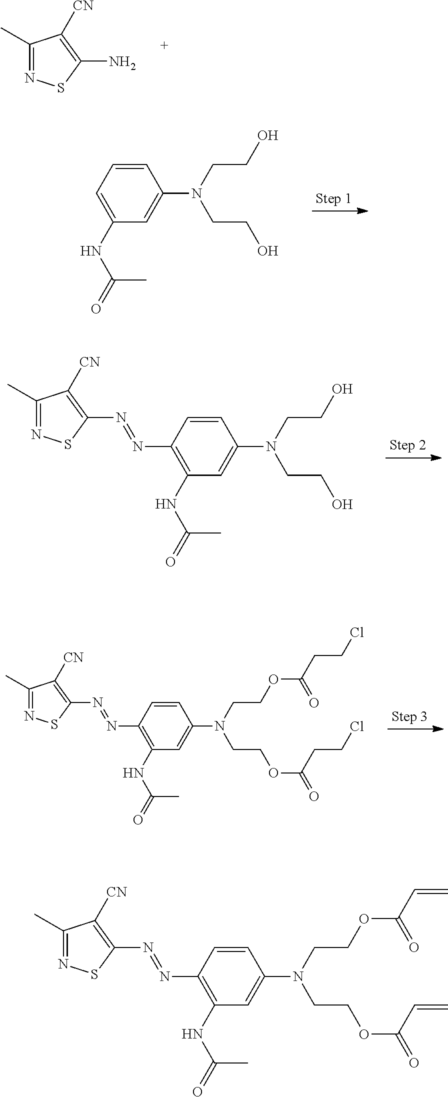

### Step 1: N-[5-{bis-(2-hydroxyethyl)-amino}-2-(4-cyano-3-methylisothiazol-5-ylazo)-phenyl]-acetamide

5-Amino-4-cyano-3-methylisothiazole (1.39 g, 0.01 mol) is stirred in 96% sulphuric acid (6 ml) at room temperature for 15 minutes. Propionic acid (4 ml) and acetic acid (8 ml) are added and the thick suspension is cooled to 0-5° C. 40% Nitrosyl sulphuric acid (3.17 g, 0.01 mol) is added dropwise and the thick reaction mixture stirred at 0-5° C. for 1.5 hours. The diazonium salt solution is added in portions to a solution of N-[3-bis-(2-hydroxyethyl)-aminophenyl)-acetamide in a mixture of ice, water and methanol containing a small amount of urea and stirred at 0-5° C. for 2 hours, adding sufficient ammonia liquor to remove mineral acidity. The product is collected by filtration, washed with cold water, dried and recrystallised from methylated spirits to yield N-[5-{bis-(2-hydroxyethyl)-amino}-2-(4-cyano-3-methylisothiazol-5-ylazo)-phenyl]-acetamide as a violet solid (2.4 g, 61%). Mp=188-189° C.; λₘₐₓ (MeOH) 546 nm (57,000), ½ band width=81 nm.

### Step 2: 3-Chloropropionic acid 2-[{3-acetylamino-4-(4-cyano-3-methylisothiazol-5-ylazo)-phenyl}-{2-(3-chloropropionyloxy)-ethyl}-amino]-ethyl ester

N-[5-{bis-(2-Hydroxyethyl)-amino}-2-(4-cyano3-methylisothiazol-5-ylazo)-phenyl]-acetamide (3.2 g, 0.00824 mol) is stirred at room temperature in THF (60 ml) containing potassium carbonate (3.5 g, 0.025 mol). β-Chloropropionyl chloride (3.17 g, 0.025 mol) is added drop wise. The reaction mixture is stirred at 40° C. overnight, cooled to room temperature and water (3 ml) is added dropwise. After stirring at room temperature for 30 minutes, the reaction mixture is filtered and the solids washed with THF until almost colourless. The organic fraction is evaporated to dryness and the ortho isomer is separated-out by flash chromatography over silica gel. The product was then recrystallised from 74OP methylated spirits to yield 3-chloropropionic acid 2-[{3-acetylamino-4-(4-cyano-3-methylisothiazol-5-ylazo)-phenyl}-{2-(3-chloropropionyloxy)-ethyl}-amino]-ethyl ester as a red crystalline solid (4.2 g, 89.5%) mp=113-116° C., λₘₐₓ (EtOAc) 532 nm, ∈ₘₐₓ 59,000, ½ band width 81 nm.

### Step 3: Acrylic acid 2-[{3-acetylamino-4-(4-cyano-3-methylisothiazol-5-ylazo)-phenyl}-{2-acryloyloxyethyl}-amino]ethyl ester

2-[{3-Acetylamino-4-(4-cyano-3-methylisothiazol-5-ylazo)-phenyl}-{2-(3-chloropropionyloxy)-ethyl}-amino]-ethyl ester (4.1 g, 0.0072 mol) is stirred at room temperature in methylene chloride (80 ml) until dissolved. Triethylamine (1.6 g, 0.0158 mol) is added dropwise and the reaction mixture is stirred overnight at 25° C. The solution is washed with water (100 ml), dried (MgSO₄) and evaporated to dryness. The preparation is repeated following the exact procedure and the combined products are recrystallised from methylene chloride/74OP methylated spirits. Acrylic acid 2-[{3-acetylamino-4-(4-cyano-3-methylisothiazol-5-ylazo)-phenyl}-{2-acryloyloxyethyl}-amino]-ethyl ester is obtained as a violet microcrystalline solid (6.8 g, 95%), mp=92-94° C., λₘₐₓ (EtOAc) 533 nm, ∈ₘₐₓ 58,000, ½ band width 81 nm.

### Example 6

### Preparation of Magenta Particles

Methyl methacrylate (20.58 g), methacrylic acid (0.42 ml), magenta dye of Example 5 (1.02 g), Vazo 67 (0.20 g), 1-Octanethiol (0.12 ml), dodecane (25.2 g), and NAD stabiliser (3.50 g) (30% by weight in 50:50 ethyl/butyl-acetate) are mixed and heated in a flask at 80° C. for two hours. The temperature is raised to 120° C. Diethanolamine (0.15 ml) is added. After 16 hours, the reaction mixture is allowed to cool to room temperature. The dispersion is filtered through a 50 micron cloth. The particles are washed with dodecane. Once the washings run colourless, the particles are redispersed in dodecane to give particle dispersion (5) comprising magenta coloured spherical particles, (376 nm), solid content 46.9%.

### Example 7

### Preparation of Magenta Anisotropic Particles with 2-hydroxyethyl Methacrylate

Particle dispersion (5) (4.26 g, 50 weight %) and dodecane (35.74 g) are mixed until homogenous. In a separate flask, NADS (3.00 g, 30 weight % solution), and 2-hydroxyethyl methacrylate (3.00 g) are stirred until homogenous. The two solutions are combined in a 100 ml round bottomed flask and stirred for 24 hours, Heptane (20.0 g) is added, the flask is degassed, refilled with a nitrogen atmosphere and heated to 85° C. V59 (60 mg) and NADS (2.0 g, 30 weight %) are mixed until homogenous, then are added to the flask, the mixture is stirred at 85° C. for 2 hours. The mixture is allowed to cool to room temperature. The resultant dispersion is filtered through glass wool. The dispersion is washed by centrifugation and the supernatant is replaced with clean dodecane. This process is repeated, the particles are redispersed in dodecane to give particle dispersion (6). Particles appear elongated by SEM; size (length 402 nm), aspect ratio (1.45).

### Example 8

### Electrophoretic Formulation Containing Magenta Anisotropic Particles Containing Dye by Dispersion Mechanism and Also Containing Charging Agent

0.06011 g of Aerosol-OT (Sigma Aldrich) and 1.2865 g dodecane (Sigma Aldrich) is added to 0.6550 g of the particles of Example 7 at 9.16 weight % and vortex mixed. The dispersion is then roller mixed overnight. Size 397.3 (nm), Electrophoretic Mobility −0.02963 μmcm/Vs), ZP −31.9 (mV).

1-17. (canceled)

18. An electrophoretic fluid comprising polymer particles having non-spherical shapes.

19. The electrophoretic fluid of claim 18, wherein the polymer particles are prepared by a process comprising the following steps:
(a) polymerising a first non-aqueous dispersion of at least one monomer, optionally at least one steric stabiliser, at least one initiator, optionally at least one polymerisable dye and optionally at least one charged co-monomer in a non-aqueous solvent,
(b) optionally cleaning the polymer particles formed in step (a) and forming a second non-aqueous dispersion of the polymer particles in a non-aqueous solvent,
(c) adding to the second non-aqueous dispersion at least one monomer having a partition coefficient different from the partition coefficient of the non-aqueous solvent, optionally at least one steric stabiliser, and at least one initiator,
(d) polymerising the second non-aqueous dispersion, and
(e) optionally cleaning the polymer particles formed in step (d).

20. The electrophoretic fluid of claim 19, wherein step (c) comprises adding to the second non-aqueous dispersion at least one monomer having a partition coefficient different from the partition coefficient of the non-aqueous solvent and different from the partition coefficient of the monomers in step (a), optionally at least one steric stabiliser, and at least one initiator.

21. The electrophoretic fluid of claim 19, wherein in step (c) the difference of the partition coefficients specified as log P values of the at least one monomer and the non-aqueous solvent is in the range of from 3 to 9.

22. The electrophoretic fluid of claim 19, wherein a non-aqueous, non-polar solvent is used in steps (a) and (b).

23. The electrophoretic fluid of claim 19, wherein the non-polar solvent used in step (a) and/or (b) is selected from the group consisting of dodecane, tetradecane, decane, nonane, tetralin, 1,5-dimethyltetralin, decalin, and mixtures thereof.

24. The electrophoretic fluid of claim 18, wherein an oil dispersible dye or a water-insoluble polymerisable dye is used.

25. The electrophoretic fluid of claim 24, wherein the polymerisable dye consists of a chromophore, one or more polymerisable groups, optional linker groups, and optional groups to modify physical properties and optionally charged group(s).

26. The electrophoretic fluid of claim 24, wherein the polymerisable dye is Disperse Red 1 methacrylate or acrylate, a dye of formula 1, a dye of formula 2, or a dye of formula 3 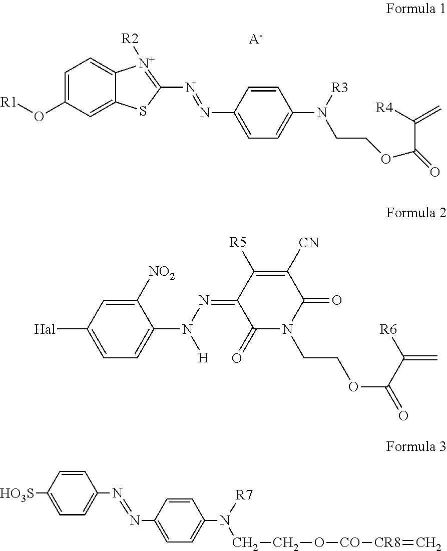
wherein
R1,R2,R3,R5, R7=alkyl, preferably C1-C4 alkyl,
R4,R6,R8=H or CH₃,
Hal=halogen,
A⁻=halogen or monobasic acid (oxo) anions.

27. The electrophoretic fluid of claim 24, wherein the polymerisable dye the polymerisable dye is a dye of formula 4 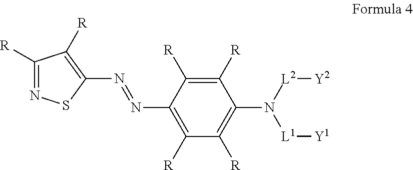
wherein
the aromatic or heteroaromatic cycles are substituted by one or more different or identical groups R selected from the group consisting of H, C1-C6 alkyl, —C(O)R′, —C(O)OR′, —NO₂, —CN, —NHCOR′, with R′, independently of one another, equal to C1-C6 alkyl, L¹ and L² are independently of one another selected from phenylene or C1-C6 alkyl, a polyether alkyl chain, or a combination thereof, and
Y¹ and Y² are independently of one another acrylate or methacrylate.

28. The electrophoretic fluid of claim 18, wherein the polymer particles have a diameter of 50-1000 nm.

29. The electrophoretic fluid of claim 24, wherein said electrophoretic fluid comprises white reflective particles.

30. The electrophoretic fluid of claim 29, wherein the coloured polymer particles and the white reflective particles have a diameter of 50-1000 nm.

31. An electrophoretic display device comprising the electrophoretic fluid of claim 18.

32. The electrophoretic display device of claim 31, wherein the electrophoretic fluid is applied by a technique selected from inkjet printing, slot die spraying, nozzle spraying, and flexographic printing, or any other contact or contactless printing or deposition technique.

33. A mono, bi, or polychromal electrophoretic device comprising coloured polymer particles having non-spherical shapes and prepared by a process comprising the following steps:
(a) polymerising a first non-aqueous dispersion of at least one monomer, optionally at least one steric stabiliser, at least one initiator, optionally at least one polymerisable dye, and optionally at least one charged co-monomer in a non-aqueous solvent,
(b) optionally cleaning the polymer particles formed in step (a) and forming a second non-aqueous dispersion of the polymer particles in a non-aqueous solvent,
(c) adding to the second non-aqueous dispersion at least one monomer having a partition coefficient different from the partition coefficient of the non-aqueous solvent, optionally at least one steric stabiliser, and at least one initiator,
(d) polymerising the second non-aqueous dispersion, and
(e) optionally cleaning the polymer particles formed in step (d).

34. The mono, bi, or polychromal electrophoretic device of claim 33, wherein step (c) comprises adding to the second non-aqueous dispersion at least one monomer having a partition coefficient different from the partition coefficient of the non-aqueous solvent and different from the partition coefficient of the monomers in step (a), optionally at least one steric stabiliser, and at least one initiator.

35. The electrophoretic fluid of claim 21, wherein in step (c) the difference of the partition coefficients specified as log P values of the at least one monomer and the non-aqueous solvent is in the range of from 4 to 9.

36. The electrophoretic fluid of claim 25, wherein the chromophore is an azo group, anthraquinone group, or phthalocyanine group.

37. The electrophoretic fluid of claim 26, wherein dye of formula 1 is a methacrylate or acrylate ester derivative of CI Basic Blue 41.

38. The electrophoretic fluid of claim 26, wherein in the dye of formula 2, Hal=C1 and R5 and R6=CH₃.

39. The electrophoretic fluid of claim 26, wherein in the dye of formula 3, R7=C₂H₅ and R8=CH₃.

40. The electrophoretic fluid of claim 26, wherein the monobasic acid (oxo) anions are acetate, propionate, lactate, methane sulphonate, p-toluenesulphonate, hydroxide, or nitrate.
